(19) United States
(12) Patent Application Publication
(10) Pub. No.: US 2016/0335232 A1
(43) Pub. Date: Nov. 17, 2016

(54) REMOTE SCRIPT EXECUTION FOR SECURE AND PRIVATE BROWSING

(71) Applicant: GOVERNMENT OF THE UNITED STATES AS REPRESETNED BY THE SECRETARY OF THE AIR FORCE, ROME, NY (US)

(72) Inventors: FRANK H. BORN, WESTERNVILLE, NY (US); DAVID FLETCHER, ROME, NY (US)

(21) Appl. No.: 14/708,501

(22) Filed: May 11, 2015

(51) Int. Cl. G06F 17/22

(52) U.S. Cl. CPC G06F 17/2247

(57) ABSTRACT

Invention provides a method and apparatus for remote script execution for secure internet browsing by filtering and partially re-writing a web page for the purpose of enabling the user to get the benefit from the complete code on the page without the risk associated with the potentially dangerous portions of code on that page. The invention executes the complete code set in a rendering computer processor that acts as an intermediary between the user's computer processor and the internet, and passing on, from the rendering computer to the user's computer, only those portions of code that can be safely rendered by the user's browser. This allows the user to see the output of potentially dangerous scripting code without being exposed to the dangers of hosting and executing that scripting code.

### STATEMENT OF GOVERNMENT INTEREST

The invention described herein may be manufactured and used by or for the Government for governmental purposes without the payment of any royalty thereon.

### BACKGROUND OF THE INVENTION

Malicious code is hosted on many web sites and is used to attack the computers of visitors to those web sites. In order to display a web site the browser downloads the web page code from the web server on the internet. The browser will then execute that code in order to show the user the content of that page. Since the page code runs in the user's browser the code is often able to successfully attack and compromise the user's computer. Advances in browser security are making it harder for a web page to attack the user through the browser, but the attackers always seem to be able to find new vulnerabilities in browsers that they can exploit or they are able to exploit old vulnerabilities in unpatched browsers.

Code that controls a web page can be divided into three types. One type is responsible for presentation and layout of the elements on the page. This function is typically done by the Hypertext Markup Language (HTML) and Cascading Style Sheet (CSS) code. Another type of code that is present in a web page is often called scripting code. This code is processed by the browser to perform complex functions such as bringing in new data from the server or to validate form inputs. There are a seemingly unlimited number of useful functions that this scripting code can accomplish but it is also the most prevalent vector used to attack a computer. The third type of code that is present in a web page is object code. This type of code will run embedded programs within the browser using the computer operating system's utilities such as the Java Runtime Environment. While the presentation and layout code is safe for the user to process in their browser, the scripting code and embedded objects are often not safe for the user's computer to execute.

Scripting code that runs in the context of a web page, as mentioned above, is both useful and dangerous. Since it provides many useful capabilities it is considered a necessary component of almost any web page. For this reason, security methods that do not allow scripting code to run in the browser will cause a severe degradation of functionality of that page. Because this code can be so complex it is currently not possible to reliably distinguish non-malicious scripting code from malicious scripting code. No existing security mechanism can rightly divide the good from the bad such that only safe scripting code will be executed. Some security mechanisms will ask users if they “trust” the web site that they are retrieving. If the user states that they trust the site then the browser is allowed to execute the scripting code on the page. This method is also deficient due to the fact that malicious code is often planted on legitimate (trusted) sites by the attackers. For that reason users cannot trust any web site to be free from malicious code.

Objects that are embedded in a web page and displayed in a browser are different from either the presentation/layout code (HTML/CSS) and the scripting code (generally JavaScript) since they are usually in binary code as opposed to ASCII code that can be read by a human. As such these objects do not act like the scripting code that needs to output HTML for the results to be seen by the user. Objects (generally) directly manipulate the pixels in their portion of the screen. The object can be made secure for the user to view, or interact with, in several different ways. These methods include 1) having the user remotely interact with it on the external browser via a Virtual Network Computer (VNC) connection, whitelisting known good objects, sandboxing the object such that any attacks contained in the object cannot escape, affect the user's browser or, subsequently, their operating system.

Methods that are currently used to accomplish browser security include the following: 1) One method involves blocking all scripting code from executing in the browser. This method is effective at stopping threats but it significantly degrades the functionality of the web page. Because of this, users of this technology will often turn off the script blocking and open themselves up to attack. 2) Another method involves viewing the entire browsing session remotely. This can be done with either a thin client setup or through a Virtual Network Connection (VNC). Both of these solutions require a high bandwidth connection between the client and the external rendering browser. This high bandwidth requirement can result in degradation in quality of the images or video received by the client. In many cases the thin client solution requires that the user possess dedicated hardware for this solution. 3) Another method uses signature analysis to identify and block known malicious scripting code. This method will not be effective against new malware nor malware that has been morphed to create a new signature. 4) Another method involves evaluation of the scripting code. This method relies on complicated algorithms to be able to identify malicious code by the actions that the code tries to accomplish. Due to the fact that it is easy to disguise the purpose of the scripting code this method will suffer from a high false negative rate. 5) Another method is identified in a technical paper entitled: “Webshield: Enabling Various Web Defense Technologies without Client Side Modifications” by Zhichun Li et al, Proceedings of the Network and Distributed System Security Symposium (NDSS), 2011. This method uses an external computer to process web page code and passes that code on to the client via updates to the Document Object Model (DOM). However, it passes on every DOM update individually to the client rather than summarizing multiple changes to the DOM and sending them at one time. The method of sending each individual DOM update to the client will result in a very high volume of traffic sent to the client and a higher computational load on the client to process all those messages. 6) Another method is presented in U.S. Pat. No. 8,307,436 to Frank Born entitled “Transformative Rendering of Internet Resources”. Unlike the present invention, U.S. Pat. No. 8,307,436 is limited to utilizing HTML image maps as the primary method for implementing the re-writing of code prior to execution in the client browser. 7) Another method is identified in a pending patent application Ser. No. 14/290,175 filed May 29, 2014 by Frank Born entitled “Web Malware Blocking through Parallel Resource Rendering”. This patent application implements a page rewriting methodology that is limited to parallel modes using an internet proxy to pass the resource to both the rendering browser and the client browser at the same time and consequently, does not cover serial modes where all code that is sent to the Client Browser first passes through the rendering browser.

### OBJECTS AND SUMMARY OF THE INVENTION

It is therefore an object of the present invention to protect internet users from malicious code (i.e. malware) using a filtering/re-writing method that is placed between the user and the source of the web resource.

It is another object of the present invention to use the filtering/re-writing method to protect internet users from malicious code for which the signatures are previously unknown.

It is another object of the present invention to use the filtering/re-writing method hosted on a transient virtual computer to effect anonymity and privacy for users of the system.

It is yet another object of the present invention to protect users from all web attacks, even those that might emanate from the computer processor holding the filtering/re-writing mechanism should the filtering/re-writing processor be compromised.

It is still another object of the present invention to safeguard outgoing traffic from a web server such that it will not contain malicious code.

It is still another object of the present invention to define multiple apparatus for implementation of the malicious code blocking mechanism.

It is still yet another object of the present invention to integrate multiple security mechanisms into a complete security package that is able to disrupt all forms of web based malicious code.

It is still yet another object of the present invention to host the rewriting/filtering mechanism on a virtual machine and manage a pool of those virtual machines such that they are frequently refreshed.

Briefly stated, the present invention provides a method and apparatus for remote script execution for secure internet browsing by filtering and partially re-writing a web page for the purpose of enabling the user to get the benefit from the complete code on the page without the risk associated with the potentially dangerous code types on that page. This is done by executing the complete code set in a rendering computer processor that acts as an intermediary between the user's computer processor and the internet, and passing on, from the rendering computer to the user's computer, only those code types that can be safely rendered by the user's browser. This includes code that was part of the original page and safe code types that were generated by the potentially unsafe code types. This allows the user to see the output of potentially dangerous code (herein termed “scripting” code) without being exposed to the dangers of hosting and executing that scripting code. The rendering computer processor passes the Document Object Model (DOM) to the client upon initial page load and, upon change of the web page, passes DOM changes to the client. Since the DOM is a complex hierarchical model, and a single change to a web page can affect so many DOM elements, it is necessary to pass on summaries of DOM changes to the client rather than to pass on every individual DOM change. This invention will block script code attacks completely including attacks that may emanate directly from the computer processor that is doing the re-writing/filtering in the event that this computer has been itself compromised. The filtering/re-writing method also provides privacy to the user by only allowing the internet servers to see the intermediary rendering computer but not the user's (i.e., client) computer. Since this intermediary rendering computer can be hosted in a virtual environment it can be frequently refreshed and all record of the user's browsing session will be deleted along with any identifying markers stored on that machine.

In a preferred embodiment of the present invention, an apparatus and method for remote script execution for secure internet browsing comprises filtering/re-writing a web page such that the user of that web page is able to receive nearly the full functionality of the page while executing only safe code types in their browser. The invention comprises at least one intermediary rendering computer processor and at least one client computer processor; a computer software program containing computer executable instructions, stored on a non-transitory medium, that is hosted on the rendering computer processor, which, when read by the rendering computer processor will process the complete code on a web page, filtering/re-write it, and pass to the client only those portions that are written in safe code types, it will also continually pass to the client updates to the page that happen after the initial page load, and a companion software program containing computer executable instructions, stored on a non-transitory medium, that is hosted on the client computer processor, which, when read by the client computer processor will receive web page code and updates thereto from the rendering computer processor, filter out any unsafe code types, and display the web page to the user based only on the code types that cannot attack the client's computer processor.

Further, in a preferred embodiment of the present invention, an apparatus and method for remote script execution for secure internet browsing provides the user of that web page nearly the full functionality of the page while executing only safe code types in their browser, where a rendering computer processor assigns identifiers to all HTML elements on the web page and sends that page to the client computer processor for execution of the safe code types and immediate display of the resulting elements, concurrently with this the rendering computer processor will execute the complete web page code and send to the client only the summarized updates to the page that were initiated by scripting code in the resource, these updates will cite the element identification assignments to ensure correct identification of elements that change, the client computer processor will also send all relevant user actions to the filtering/re-writing apparatus for subsequent processing of any scripting code that is invoked due to these user actions.

Yet further in a preferred embodiment of the present invention, an apparatus and method for remote script execution for secure internet browsing provides the user of that web page nearly the full functionality of the page while executing only safe code types in their browser, browser privacy is accrued by the use of this apparatus since the internet servers and network infrastructure will not deal directly with the user's computer but rather it will deal with the apparatus hosting the filtering/re-writing, such being in a virtual environment that is refreshed regularly thus eliminating all tracking cookies and other identifiers used to track the user.

The present invention solves the malicious script code problem by executing potentially dangerous scripting code on an external browser and sending only the outputs of that execution to the user. This solution works since most script code execution outputs result in changes to what the user sees. Thus the scripting code, when run, will develop or import new HTML code that can safely be processed by the user. In order to accomplish remote execution of the scripting code it is necessary to also identify which user events are significant (such as mouse click events) and pass those back to the external browser such that scripting code that is tied to those events can be run. Lastly, in addition to securing the user's computer from malicious scripting code, the present invention also provides the user with greatly increased privacy due to the fact that most user tracking methods require the scripting code to be run on the user's computer. The features of the present invention that cause the scripting code to be run on an external computer will mean that the web site can only track that external computer, not the client's computer. Also, since the external computer can be frequently regenerated, through virtual machine technology, all tracking of the user will be broken when that computer is regenerated.

The present invention describes a method for filtering out certain code types in incoming web pages and re-writing those web pages before passing them on to the user. This results in the user being safe from both known and unknown methods of attack that could have emanated from the removed code types. The method and apparatus allows the resource to retain the functionality contained in the removed code by executing it remotely in an external browser. This invention also safeguards users from attacks by that external browser should the external browser or its operating system be successfully compromised. Scripting code will be filtered out of the client's version of the web page and it will not be executed in the client browser even if it is passed from the external browser to the client browser. Methods for efficiently passing user actions back to the external browser are defined as well as methods for the external browser to correctly identify the page elements that need to be changed or deleted. In addition to security, browsing privacy is a valuable outcome of using this invention.

The present invention is implemented “without client side modifications” as the title states. The present invention accomplishes this even while the current technology has to send JavaScript code to the client with each page that is loaded and with the security risks associated with downloading and running JavaScript received from the internet. The present invention alleviates this risk. The present invention only requires the client to install executable code one time on their machine.

The protection method described in the present invention can be implemented in several ways and for several distinct purposes. It can be hosted adjacent to the user's computer processor but in a sandbox or virtual machine. It can be hosted remotely at a proxy server. This protection method can be hosted such that the initial HTML/CSS rendering of the page is accomplished in the client browser at the same time as the external browser is rendering the complete page (including the scripting code). This protection method can be hosted adjacent to a web server such that no unknown exploits can be served to customers from that server. It can be hosted on a virtual machine (or Linux container) in the cloud that can be refreshed regularly. User initiated tailoring of the methods involved in this invention would also allow the user to establish what level of risk (and privacy) they can tolerate (desire) when accessing a web page. As an example of tailoring, the user might want all object code blocked, or they might want all images to be passed through the rendering processor rather than receiving them directly from the internet resource provider(s).

### BRIEF DESCRIPTION OF THE DRAWINGS

FIG. 1 depicts a flow diagram that shows the steps for filtering/re-writing a web page and passing it and subsequent updates on to the client computer processor.

FIG. 2 depicts a flow diagram of the present invention that shows the steps for filtering/re-writing a web page after allowing the initial version of the page, without any script code execution, to be rendered concurrently on both the rendering computer processor and the client processor.

FIG. 3 depicts the relationship and interaction between the physical (or virtual) assets in an implementation of the present invention wherein the rendering computer processor(s) works on behalf of the client to filter/re-write a web page for passing on said page to the client computer processor.

FIG. 4 depicts the relationship and interaction between the physical (or virtual) assets in an implementation of the present invention wherein the rendering computer processor(s) works on behalf of the Internet resource provider to filter/re-write web pages being passed on to any client computer processor accessing content from that Internet resource provider.

FIG. 5 depicts the relationship and interaction between the physical (or virtual) assets in an implementation of the present invention wherein the filtering/re-writing mechanism is hosted on an Internet proxy or internet router processor(s) and works on behalf of the client computer processor to filter/re-write a web page for passing on said page to the client computer processor.

FIG. 6 depicts the relationship and interaction between the physical or virtual assets in an implementation of the present invention wherein the rendering computer processor(s) are hosted adjacent to an Internet proxy and works on behalf of the client to filter/re-write a web page for passing on said page to the client computer processor.

FIG. 7 presents alternate methods for implementing the present invention's step of determining what user actions need to be sent from the client computer processor to the rendering computer processor.

### DETAILED DESCRIPTION OF THE PREFERRED EMBODIMENT

The present invention safeguards client computers that access web pages on the internet from malicious code that accompanies many of those web pages. In particular the invention presents a method and apparatus for remotely interacting with a web page such that the user (client) of that web page can receive nearly full functionality of the web page without any of the risk associated with running the potentially dangerous scripts that are contained in the page on their computer. In addition to ensuring that malicious scripting code in a web page cannot attack the client, the present invention also provides the added benefit of masking the identity of the client computer. This would keep internet resource providers from monitoring the user's private actions while accessing the web.

Web based attacks that come through malicious scripting code that accompanies a web page will be completely blocked by the present invention. In the description of the present invention the generalized term “scripting” code or “scripts” is used to identify JavaScript and other client side interpreted code. Since scripting code is necessary to provide much of the interactivity in a web page it cannot be removed without also removing the interactive nature of the page. The present invention enables the client to receive the interactive functions provided by the scripting code without having to run the scripting code on their own computer. An external computer is used to process the scripting code. Once the scripting code has been executed it will usually make changes to the HTML code in the page so that the results can be displayed to the user. Thus, most of the outputs of the potentially dangerous scripting code are in the form of HTML code that can be safely passed to the client browser. The result of the present invention is that it gives the client nearly complete functionality of a web page without any of the risk associated with running the scripting code.

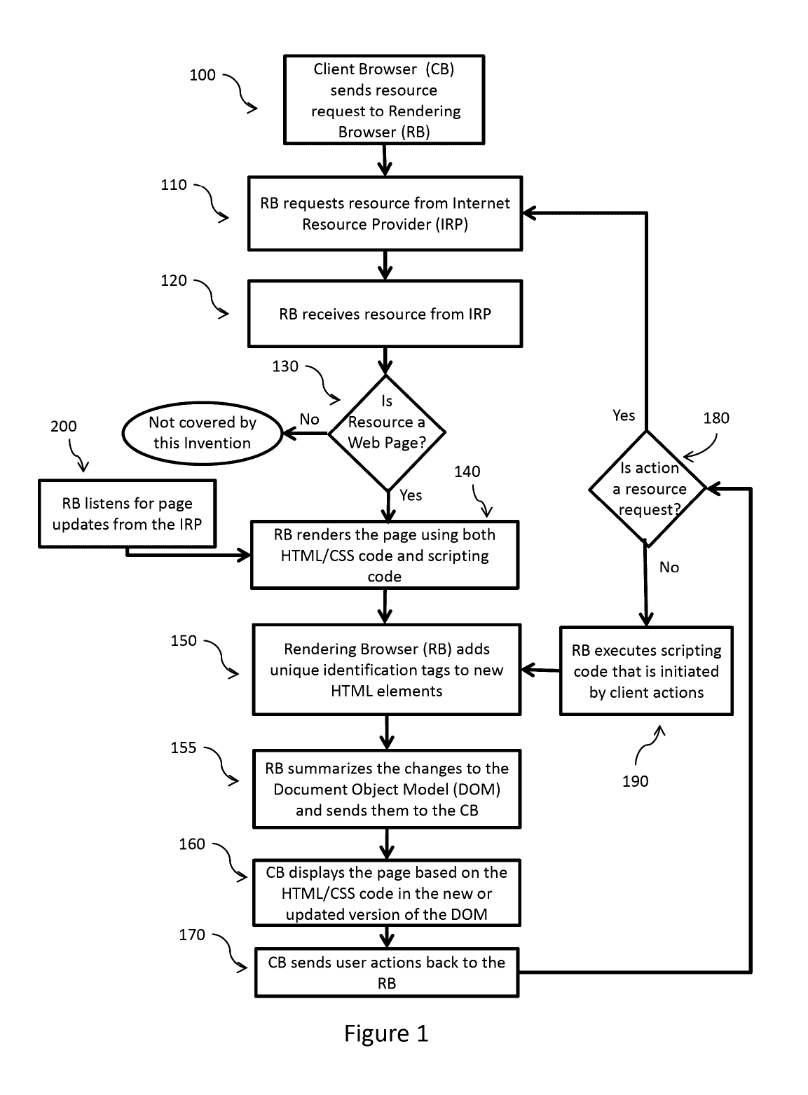

Referring to FIG. 1, the process flow for the preferred embodiment of the present invention is shown and can be described as follows: a process flow for the preferred embodiment of the present invention that shows the steps for filtering/re-writing a web page and passing it and subsequent updates on to the client computer processor. This description will reference the client computer processor and client browser interchangeably rather than strictly the computer processor(s) on which they depend since most of the actions are accomplished by software that runs the browser or runs in the browser. Similarly, this description will reference the renderer computer processor and renderer browser interchangeably.

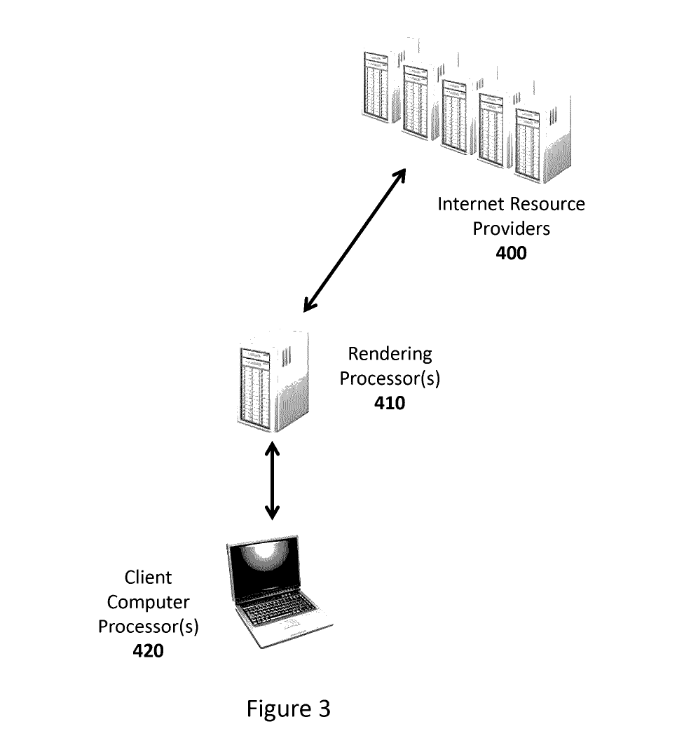

The first action is for the client browser within the client computer processor (see FIG. 3, 420) to initiate a resource request for an internet (i.e., Web) resource. The client browser sends a request for an internet resource 100 to the rendering browser within the rendering processor (see FIG. 3, 410). The rendering browser, acting as an intermediary, will forward that resource request on to the Internet Resource Provider for that particular internet resource 110. The rendering browser will then receive the requested resource back from the internet resource provider 120. If it is determined that this resource is a web page 130 the rendering browser will render the page using both the presentation code (HTML/CSS) and scripting code (generally JavaScript) 140. Optionally the rendering browser, prior to rendering the page, may use signature analysis methods to disallow any scripting code that is known to be malicious from running in the rendering browser. Resources returned from the internet that are determined to not be web pages 130 must be handled differently than web pages. Safe rendering of these resources is not covered by the present invention. The rendering browser will add a unique identifier to each HTML element 150. The rendering browser summarizes the changes to the Document Object Model (DOM) and sends them to the client browser 155. The unique identifiers on HTML elements are necessary to facilitate communication between the rendering browser and the client browser about what elements have been updated or deleted. The client browser will use the HTML and CSS code in the document object model to display the page to the user 160. The client browser will also have safeguards in place to ensure that any scripting code received from the internet, even if it comes from the rendering browser, will not be executed by or in the client browser. The effect of this safeguard is that the rendering browser, should it be compromised, cannot launch scripting code attacks against the client browser. User actions, including commands such as mouse clicks and keystrokes, will continually be passed from the client browser to the rendering browser 170. The rendering browser will continually listen for user actions being passed from the client browser. If the action initiated by the client browser is a request for a new internet resource, 180 the rendering browser will relay that request to the appropriate internet resource provider 110. If the action in the client browser is other than a resource request that action will be duplicated in the rendering browser and any scripting code that is initiated by that action will be allowed to run in the rendering browser 190. When scripting code is run it will generally create new HTML or make changes to the document object model to make existing HTML elements visible or hidden. These changes to the HTML or document object model will be passed back to the client browser after any new elements have been given a unique identification tag 150. In addition to waiting for client actions the rendering browser also continually listens for page updates being pushed from the internet resource provider 200 if dictated to do so by the code in the page.

### Alternate Embodiment of the Present Invention

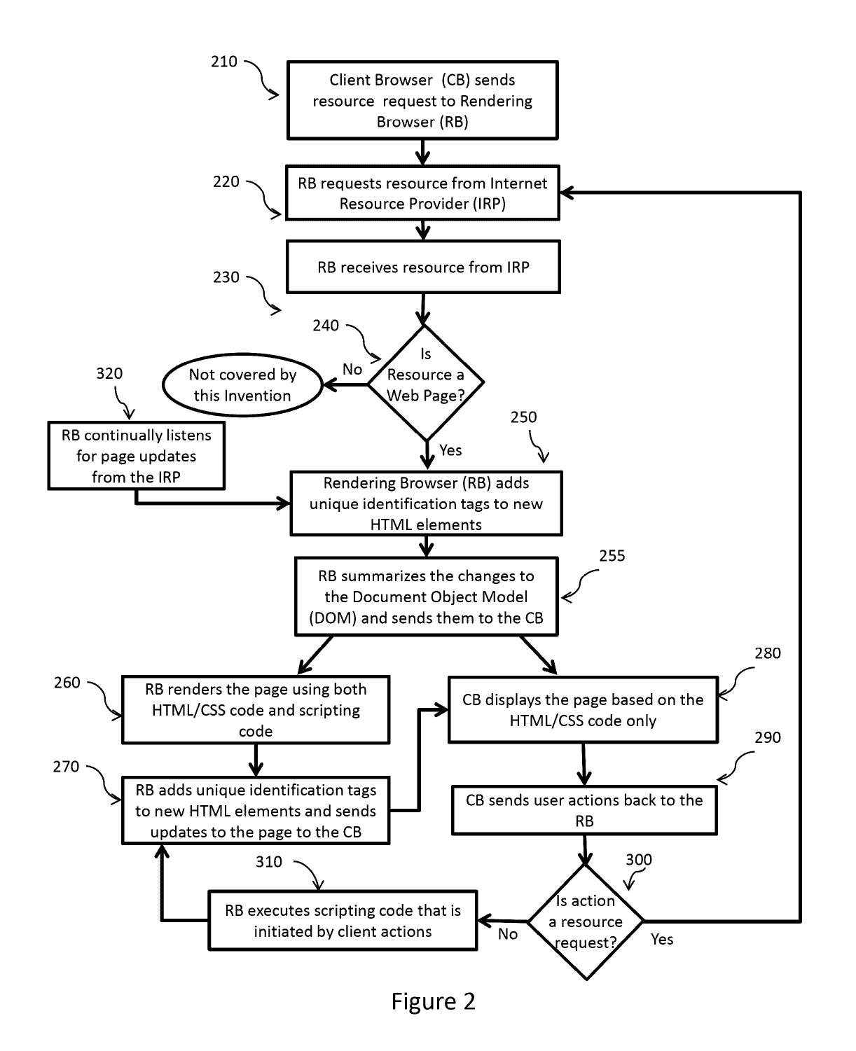

Referring to FIG. 2, the process flow for an alternate embodiment of the present invention is shown and can be described as follows: a flow diagram that shows the steps for filtering/re-writing a web page after allowing the initial version of the page, without any script code execution, to be rendered concurrently on both the rendering processor and the client processor. This description will reference the client and rendering browsers rather than the computer processor(s) on which they depend since most of the actions are accomplished by software that runs the browser or runs in the browser.

The first action is for the client browser within the client computer processor (see FIG. 3, 420) to initiate a resource request 210 for a Web resource. The client browser sends a request for an internet resource to the rendering browser within the rendering processor (see FIG. 3, 410). The rendering browser, acting as an intermediary will forward that resource request on to the provider for that particular internet resource 220. The rendering browser will then receive the requested resource back from the internet resource provider 230. If it is determined that this resource is a web page, 240 the rendering browser will then add a unique identifier to each HTML 250. The rendering browser summarizes the changes to the Document Object Model (DOM) and sends them to the client browser 255. Resources returned from the internet that are determined to not be web pages 240 must be handled differently than web pages. Safe rendering of these resources is not covered by the present invention. The rendering browser will render the page using both the presentation code (HTML/CSS) and scripting code (generally JavaScript) 260. Optionally the rendering browser may use signature analysis methods to disallow any scripting code that is known to be malicious from running in the rendering browser. In parallel with the rendering browser rendering the page 260, the client browser will use the HTML and CSS code in the original page code to display the page to the user 280. The client browser will also have safeguards in place to ensure that any scripting code received from any internet resource provider, including the rendering browser, will not be executed by or in the client browser. The effect of this safeguard is that the rendering browser, should it be compromised, cannot launch scripting code attacks against the client browser. The rendering browser will add unique identifiers to new HTML elements and send HTML code updates that have accrued due to the scripting code executing after the initial page was loaded to the client browser 270. The unique identifiers allow the client browser to correctly identify the elements that the rendering browser indicates should be updated or deleted. User actions such as mouse clicks and keystrokes will continually be passed from the client browser to the rendering browser 290. The rendering browser will continually listen for user actions being passed from the client browser. If the action initiated by the client browser is a request for a new internet resource 300, the rendering browser will relay that request to the appropriate internet resource provider 220. If the action in the client browser is other than a resource request, that action will be duplicated in the rendering browser and any scripting code that is initiated by that action will be allowed to run in the rendering browser 310. When scripting code is run it will generally create new HTML or make changes to the document object model to make existing HTML elements visible or hidden. These additions or changes to the document object model will be passed back to the client browser after any new elements have been given a unique identification tag 270. In addition to listening for client actions the rendering browser also continually listens for page updates being pushed from the internet resource provider if dictated to do so by the code in the page 320.

Referring to FIG. 3 this diagram shows the general placement and interaction of the processors involved in an embodiment of the present invention wherein the rendering processor(s) works on behalf of the client to filter/re-write a web page for passing on a safe version of said page to the client. For this description the term “computer processor” will also include multicore processor computers or multiprocessor computers. They could also be “virtual” processors, meaning that they are composed entirely of software that runs on another machine. The Rendering Computer Processor 410 is situated between the Internet Resource Providers 400 and Client Computer Processor 420. Within the Rendering Computer Processor the bulk of the work is being done in the Rendering Browser that is referenced in FIG. 1 and FIG. 2. Similarly, within the Client Computer Processor the bulk of the work is being done within the Client Browser that is referenced in FIG. 1 and FIG. 2. Interaction shown in FIG. 3 is as follows: In response to a request from the Client Computer Processor 420 the Rendering Computer Processor 410 will request and receive Web resources and updates to those web resources from the Internet Resource Providers 400 through an internet connection. The Rendering Processor 410 will then interact with the Client Processor 420 continually sending it code and data from the page according to the steps of either FIG. 1 or FIG. 2. The Client Computer Processor 420 will continually send the user's actions to the Rendering Processor 410 for processing.

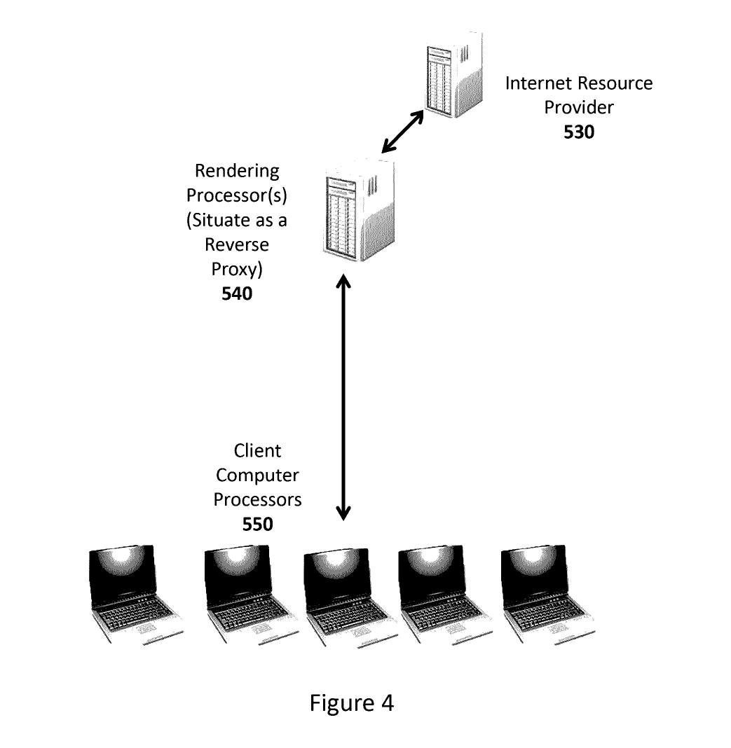

Referring to FIG. 4 this diagram shows the general placement and interaction of the processors involved in an embodiment of the present invention. This diagram depicts the relationship and interaction between the physical (or virtual) assets in an implementation of this invention wherein the rendering processor(s) works on behalf of an Internet Resource Provider to filter/re-write web pages being passed on to clients accessing content from that Internet Resource Provider. For this description the term “computer processor” will also include multicore processor computers or multiprocessor computers. They could also be “virtual” processors, meaning that they are composed entirely of software that runs on another machine. The Rendering Computer Processor 540 is located between the Internet Resource Provider 530 and Client Computer Processors 550, just as in FIG. 3, but in this implementation it acts on behalf of the Internet Resource Provider 530. While the Rendering Processor still performs the same functions outlined in FIG. 1 and FIG. 2, and with the same objective—to provide security to the Client Computer Processors 550, it is employed on the behalf of a particular Internet Resource Provider 530 to ensure that no malicious scripting code is sent out from that Internet Resource Provider. Interactions in FIG. 4 are identical to those in FIG. 3. The only difference being that the Rendering Processor 540 will serve multiple Client Processors 550 but only one Internet Resource Provider 530.

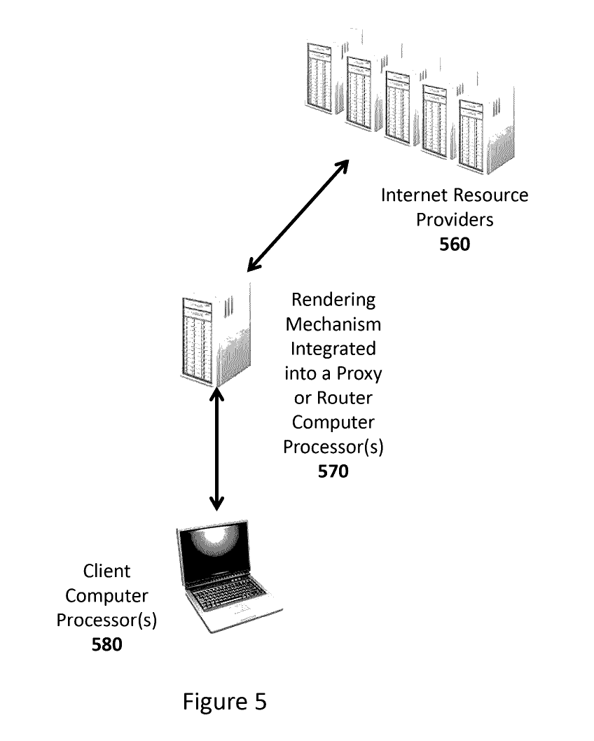

Referring to FIG. 5 this diagram shows the general placement and interaction of the processors involved in an embodiment of the present invention wherein the rendering processor(s) works on behalf of the client to filter/re-write a web page for passing on said page to the client. For this description the term “computer processor” will also include multicore processor computers or multiprocessor computers. They could also be “virtual” processors, meaning that they are composed entirely of software that runs on another machine. In this case the Rendering Mechanism is integrated into a Proxy Computer Processor or a Router Computer Processor 570 and is situated between the Internet Resource Providers 560 and Client Computer Processor 580. The Rendering Processor still performs the same functions outlined in FIG. 1 and FIG. 2, and with the same objective—to provide security to the Client Computer Processors 580. Interactions in FIG. 5 are identical to those in FIG. 3.

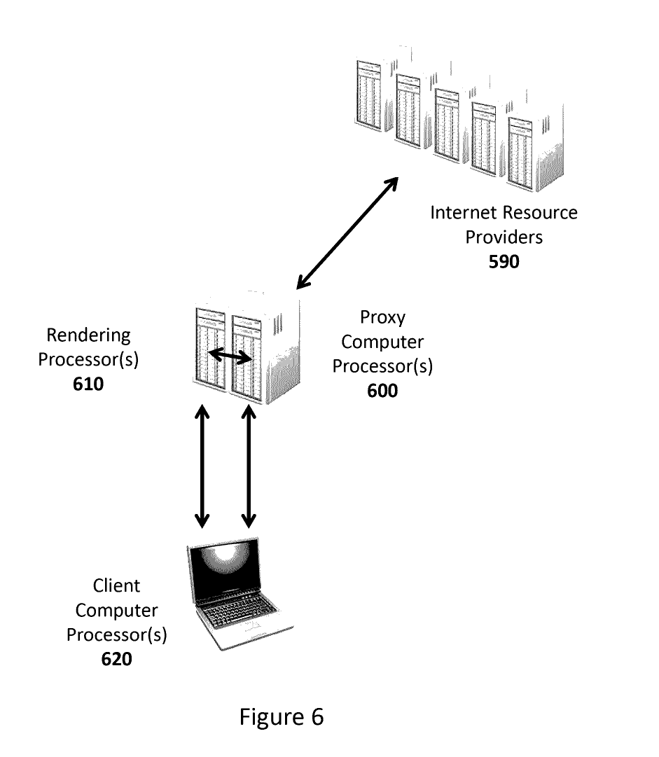

Referring to FIG. 6 this diagram shows the general placement and interaction of the processors involved in an embodiment of the present invention wherein the rendering processor(s) works on behalf of the client to filter/re-write a web page for passing on said page to the client. For this description the term “computer processor” will also include multicore processor computers or multiprocessor computers. They could also be “virtual” processors, meaning that they are composed entirely of software that runs on another machine. In this case the Rendering Processor 610 is situated adjacent to a Proxy Computer Processor 600. Both of these are situated between the Internet Resource Providers 590 and Client Computer Processor 620. The Rendering Processor 610 still performs the same functions outlined in FIG. 1 and FIG. 2 except that it's communication with the Internet Resource Providers 590 is passed through the Proxy Computer Processor 600. Interactions involving the Client Computer Processor 620 have changed in that some of the content of web pages, such as images, can be passed directly to it from the Proxy Computer Processor 600.

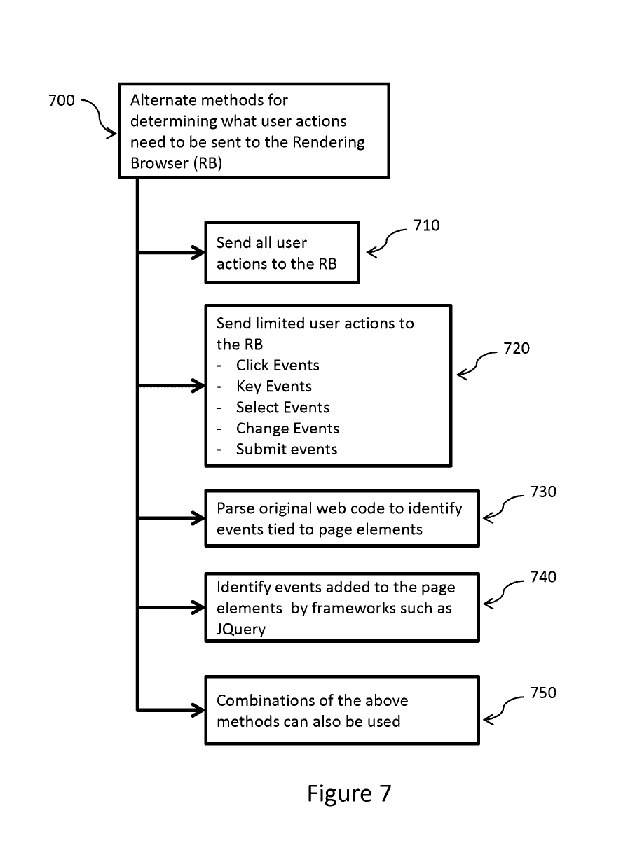

Referring to FIG. 7 this diagram shows alternate methods for determining what user actions are significant and need to be passed from the client browser to the rendering browser. Script code is often tied to specific events on specific web page elements. For example, when a user enters text into a search engine text box that often will be the signal that some scripting code needs to run. That scripting code will then take the entered text and go retrieve from the internet suggestions for what the user might be trying to type. Several alternate methods are presented for determining what user actions the rendering browser needs to know about 700. The simplest method for determining what user actions to send to the client is just to send all the events 710. This solution is easy to implement but it will result in a large amount of traffic going from the client browser to the rendering browser. The primary events that are recognized by the browser are click events, key events, change events, select events, submit events and mouse events. Since mouse events include the “mouseover” events, then this option would require the client browser to send data to the rendering browser each time the mouse pointer passes over any element on the page. Another alternate method for determining what user actions to send to the rendering browser is to send all user actions that are likely to trigger some type of action on the rendering browser 720. The set of user actions that are likely to trigger actions include click events, key events, select events, change events and submit events. Another alternate method for determining what user actions to send to the rendering browser requires parsing (understanding) of the page code to identify what elements have events tied to them and passing the appropriate user actions on those elements back to the rendering browser 730. Another alternate method for determining what user actions to send to the rendering browser is accomplished by evaluating standard JavaScript frameworks such as JQuery, if they are used by the web page, to tie user actions to script code execution 740. Knowledge of the framework will allow code in the rendering browser to identify elements and associated actions that will trigger script execution and need to be tracked in the client browser. These elements can then be tagged in the client browser and client actions on these elements can be passed back to the rendering browser. Another alternate method for determining what user actions to send to the rendering browser involves using a combination of the other methods (710, 720, 730, 740) 750.

What is claimed is

1. In a system having
at least one rendering computer processor having a rendering browser,
at least one client computer processor having a client browser, and
at least one internet resource provider having a connection to the internet,
a method for remote script execution for secure internet browsing, comprising the steps of
causing said rendering browser to retrieve from said internet resource provider an internet resource upon request from said client browser;
when said internet resource is a web page, causing said rendering browser to render said internet resource;
causing said rendering browser to send a Document Object Model of said rendered internet resource and, subsequently, summarized updates thereto to said client browser for display therein; and
causing said client browser to display an internet resource page based on said Document Object Model.

2. The method of claim 1 wherein said step of rendering said internet resource further comprises the steps of:
rendering said internet resource using both presentation code and scripting code; and
adding unique identification tags to said presentation code.

3. The method of claim 2, wherein said presentation code comprises Hyper Text Markup Language (HTML) code and Cascading Style Sheet (CSS) code.

4. The method of claim 2, wherein said scripting code further comprises JavaScript code.

5. The method of claim 2, wherein said step of rendering said internet resource further comprises the step of continuously listening for internet resource page updates from said internet resource provider.

6. The method of claim 5, further comprising the following steps:
said client browser continually sends user commands to said rendering browser for action;
when said user command is a request for internet resources, said rendering browser makes said request from said internet resource provider; and
when said user command is not a request for internet resources, said rendering browser executes any said scripting code that is initiated by said request.

7. In a system having
at least one rendering computer processor having a rendering browser,
at least one client computer processor having a client browser, and
at least one internet resource provider having a connection to the internet,
a method for remote script execution for secure internet browsing, comprising the steps of
causing said rendering browser to retrieve from said internet resource provider an internet resource upon request from said client browser; and
when said internet resource is a web page, concurrently
causing said rendering browser to render said internet resource; and
causing said client browser to display said internet resource.

8. The method of claim 7, wherein said step of rendering said internet resource further comprises
rendering said internet resource using both presentation code and scripting code;
adding unique identification tags to said presentation code; and
sending updates to said rendered internet resource to said client browser.

9. The method of claim 8, wherein said step of causing said client browser to display said internet resource further comprises
displaying said internet resource based on said presentation code; and
updating said presentation code after said internet resource is initially displayed based on updates from said step of adding unique identification tags.

10. The method of claim 9, wherein said presentation code comprises Hyper Text Markup Language (HTML) code and Cascading Style Sheet (CSS) code.

11. The method of claim 10, further comprising the following steps:
said client browser continually sends user commands to said rendering browser for action;
when said user command is a request for internet resources, said rendering browser makes said request from said internet resource provider; and
when said user command is not a request for internet resources, said rendering browser executes any said scripting code that is initiated by said request.

12. The method of claim 11, further comprising the step of ensuring said client browser does not execute any scripting code that may be received from any internet provider including said rendering browser.

13. An apparatus for remote script execution for secure internet browsing, comprising:
at least one rendering computer processor;
at least one client computer processor;
at least one internet resource provider computer processor having a connection to the internet; and
a computer software program containing computer executable instructions stored on a non-transitory medium, which, when read by said rendering computer processor and said client computer processor, will render the contents of said internet resources by
causing said rendering computer processor to retrieve from said internet resource provider computer processor an internet resource upon request from said client computer processor;
when said internet resource is a web page, causing said rendering computer processor to render said internet resource;
causing said rendering computer processor to send a Document Object Model of said rendered internet resource and, subsequently, summarized updates thereto to said client computer processor for display therein; and
causing said client computer processor to display an internet resource page based on said Document Object Model.

14. The apparatus of claim 13, wherein said rendering computer processor
renders said internet resource using both presentation code and scripting code; and
adds unique identification tags to said presentation code.

15. The apparatus of claim 14, wherein
said presentation code comprises Hyper Text Markup Language (HTML)
code and Cascading Style Sheet (CSS) code; and
said scripting code further comprises JavaScript code.

16. The apparatus of claim 15, wherein
said client computer processor continually sends user commands to said rendering computer processor for action;
when said user command is a request for internet resources, said rendering computer processor makes said request from said internet resource provider computer processor; and
when said user command is not a request for internet resources, said rendering computer processor executes any said scripting code that is initiated by said request.

17. An apparatus for remote script execution for secure internet browsing, comprising:
at least one rendering computer processor;
at least one client computer processor;
at least one internet resource provider computer processor having a connection to the internet; and
a computer software program containing computer executable instructions stored on a non-transitory medium, which, when read by said rendering computer processor and said client computer processor, will render the contents of said internet resources by
causing said rendering computer processor to retrieve from said internet resource provider computer processor an internet resource upon request from said client computer processor; and
when said internet resource is a web page, concurrently
causing said rendering computer processor to render said internet resource; and
causing said client computer processor to display said internet resource.

18. The apparatus of claim 17, wherein said rendering computer processor
renders said internet resource using both presentation code and scripting code;
adds unique identification tags to said presentation code; and
sends updates to said rendered internet resource to said client computer processor.

19. The apparatus of claim 18, wherein said rendering computer processor
displays said internet resource based on said presentation code; and
updates said presentation code after said internet resource is initially displayed based on updates from said step of adding unique identification tags.

20. The apparatus of claim 19, wherein
said client computer processor continually sends user commands to said rendering computer processor for action;
when said user command is a request for internet resources, said rendering computer processor makes said request from said internet resource provider computer processor; and
when said user command is not a request for internet resources, said rendering computer processor executes any said scripting code that is initiated by said request.
